(19) United States
(12) Patent Application Publication
(10) Pub. No.: US 2010/0145697 A1
(43) Pub. Date: Jun. 10, 2010

(54) SIMILAR SPEAKER RECOGNITION METHOD AND SYSTEM USING NONLINEAR ANALYSIS

(75) Inventors: Young-Hun Kwon, Suwon (KR); Kun-Sang Lee, Seoul (KR); Sung-IL Yang, Suwon (KR); Sung-Wook Chang, Ansan (KR); Jung-Pa Seo, Kimhe (KR); Min-Su Kim, Incheon (KR); In-Chan Baek, Incheon (KR)

Correspondence Address: OCCHIUTI ROHLICEK & TSAO, LLP, 10 FAWCETT STREET, CAMBRIDGE, MA, 02138, US

(73) Assignee: IUCF-HYU INDUSTRY-UNIVERSITY COOPERATION FOUNDATION HANYANG UNIVERSITY, Seoul (KR)

(21) Appl. No.: 12/607,532

(22) Filed: Oct. 28, 2009

Related U.S. Application Data
(63) Continuation of application No. 11/008,687, filed on Dec. 10, 2004, now abandoned.

(30) Foreign Application Priority Data
Jul. 6, 2004 (KR) 10-2004-0058256

(51) Int. Cl. G10L 17/00

(52) U.S. Cl. 704/247; 704/E17.001

(57) ABSTRACT

Disclosed herein is a similar speaker recognition method and system using nonlinear analysis. The recognition method extracts a nonlinear feature of a sound signal through nonlinear analysis of the sound signal and combines the nonlinear feature with a linear feature such as spectrum. The method transforms sound data in a time domain into status vectors in a phase domain and uses a nonlinear time series analysis method capable of representing nonlinear features of the status vectors to extract nonlinear information of a sound. The method can overcome technical limitations of conventional linear algorithms. The recognition method can be applied to sound-related application systems other than speaker recognition systems.

### CROSS-REFERENCE TO RELATED APPLICATIONS

This application is a continuation of U.S. Ser. No. 11/008,687, filed on Dec. 10, 2004, which itself claims and requests a foreign priority, through the Paris Convention for the Protection of Industry Property, based on a patent application filed in the Republic of Korea (South Korea) with the filing date of Jul. 26, 2004 and patent application number 10-2004-0058256. The contents of the above-identified applications are hereby incorporated by reference in their entirety.

### BACKGROUND OF THE INVENTION

1. Field of the Invention

The present invention relates to a similar speaker recognition method and system using nonlinear analysis. More particularly, the invention relates to a similar speaker recognition method using a nonlinear feature of a sound signal obtained through nonlinear analysis and a speaker recognition system using a combination of linear and nonlinear features.

2. Background of the Related Art

As an example of the prior art, there has been disclosed an International Publication No. WO02085215 A1 (publication date: Oct. 31, 2003) entitled “Chaos theoretical Human Factor Evaluation Apparatus”, which detects a Lyapunov index from a speech signal and predicts the psychosomatic activity using a change in the Lyapunov index.

Japanese Patent No. 99094 (issued on Apr. 4, 2003) proposes a speech processing apparatus that processes a speech signal of a speaker only when a Lyapunov index of the speech signal exists in a specific region.

Recently, speaker recognition has become an important technique of sound processing. In real life, speaker recognition is required for major public places to which only authenticated speakers can gain an access. However, the speaker recognition has not been activated, compared to other biometric systems, due to a technical limitation in that speaker recognition rates for speakers having similar voices are low when conventional linear analysis methods are employed although the speaker recognition is easy to use and has a high economical value. This is caused by the following several technical limitations of the linear analysis techniques.

(1) Deterioration of recognition performance in noisy environments.

(2) Unstable speaker recognition rate due to a change in the voice of each speaker or a change in the tone of the speaker.

(3) Low speaker recognition rate in case of speakers having similar voices.

Recently, new techniques for solving the first noisy environment problem and the second unstable speaker recognition rate problem and improving a recognition rate of a speaker recognition system have been proposed. However, the third problem has not been solved yet.

It is difficult to distinguish speakers having similar voices from one another even when noises have been completely removed. Particularly, it is very difficult to distinguish similar voices from one another using conventional linear analysis.

Since most of conventional methods for extracting sound features are carried out in a spectrum domain, the sound features of a speaker is restricted to the spectrum domain. This restriction causes a problem in that similar sounds cannot be distinguished from one another using the features extracted from the spectrum domain even in the spectrum domain. Particularly, it is very difficult to distinguish the similar sounds from one another using the conventional linear analysis such as spectrum analysis.

FIG. 1 is a Formant graph with respect to “female pair 2”, FIG. 2 is a Formant graph with respect to “female pair 1”, and FIG. 3 is a Formant graph with respect to “male pair 1”. Here, the Formant means a frequency band on which speech spectra are concentrated. Among sound data used in FIG. 1, sounds of “female pair 2” have very similar Formants. Thus, they are hardly distinguished from each other in the spectrum domain. This means that fundamental frequencies of the two speakers are similar to the form of a sound generation source.

Accordingly, it is difficult to distinguish the speakers from each other using linear features based on sound spectrum. In the case of “female pair 1” and “male pair 1”, the two speakers can be distinguished from each other through the second Formants (b) and the third Formants (c) although the first Formants (a) are similar to each other. Accordingly, the two speakers can be discriminated from each other using linear features such as MFCC as shown in FIGS. 2 and 3. That is, when the linear feature is used, the sounds of the two speakers can be distinguished from each other in the case of “female pair 1” and “male pair 1” but, in the case of “female pair 2”, the sounds cannot be distinguished from each other. However, the sounds of the two speakers of “female pair 2” represent different attractors (sets representing dynamic characteristic of a to-be-analyzed signal in the phase domain) in the phase domain. Thus, the sounds of the two speakers of “female pair 2” can be distinguished from each other in the phase domain that is a nonlinear space.

Accordingly, it is required to consider a method of extracting sound characteristics other than linear features in terms of characteristics of sound signals that are nonlinear signals.

### SUMMARY OF THE INVENTION

Accordingly, the present invention has been made to solve the above problems occurring in the prior art, and it is an object of the present invention is to solve the problem of low speaker recognition rate obtained when speakers have similar sounds by applying a nonlinear information extracting method to the analysis of sound signals.

Another object of the present invention is to provide a method for improving the recognition rate of a speaker recognition system through combination of linear and nonlinear features of sound signals.

That is, the present invention extracts a nonlinear feature from a sound signal and combines the nonlinear feature with the existing linear feature to provide a solution of a problem that an unstable speaker recognition rate is produced when speakers have similar sounds.

To accomplish the above objects, according to one aspect of the present invention, there is provided a similar speaker recognition method using nonlinear analysis, which includes the steps of: transforming a sound signal into a sound signal in a phase domain; applying nonlinear time series analysis to the sound signal in the phase domain to extract a nonlinear feature from the sound signal; and combining the nonlinear feature with existing linear feature.

The step of extracting the nonlinear feature includes selecting any one of a Lyapunov index, a correlation dimension and a Kolmogorov dimension. The Lyapunov index includes a Lyapunov spectrum or a Lyapunov dimension.

According to another aspect of the present invention there is also provided a similar speaker recognition system including a linear analyzer for analyzing a sound signal through a linear analysis method to extract a linear feature from the sound signal, a first recognizer for matching the linear feature of the sound signal with linear features of a previously trained sound, a nonlinear analyzer for analyzing the sound signal through a nonlinear analysis method to extract a nonlinear feature from the sound signal, a second recognizer for matching the nonlinear feature with nonlinear features of the previously trained sound, and a logic element for combining the results of the two recognizers to output a final recognition result.

A method for combining the results of the two recognizers of the similar speaker recognition system includes the steps of: matching the linear feature of the sound signal of a speaker with the linear features of the previously trained sound through a recognizer; allowing access of the speaker when the linear feature is matched with the linear features of the previously trained sound and switching to nonlinear analysis when the linear feature is not etched with linear features of the previously trained sound; matching the nonlinear feature with the nonlinear features of the previously trained sound through a recognizer; and allowing access of the speaker when the nonlinear feature is matched with the nonlinear features of the previously trained sound and refusing access of the speaker when the nonlinear feature is not matched with the nonlinear features of the previously trained sound. Here, it is also possible to carry out recognition using the nonlinear feature first and then perform the linear analysis.

Furthermore, when linear and nonlinear features are simultaneously used, appropriated weights can be respectively given to the linear and nonlinear features and input to a recognizer. Otherwise, the linear and nonlinear features of the sound signal are respectively matched with linear and nonlinear features of the previously trained sound to extract an error between the linear feature of the sound signal and the linear features of the previously trained sound and an error between the nonlinear feature of the sound signal and the nonlinear features of the previously trained sound. Then, appropriate weights are respectively given to the errors and input to a final recognizer.

The speaker recognition system of the present invention uses both of nonlinear and linear features of a speech signal. The linear feature is used for distinguishing speakers having different Formants from each other and the nonlinear feature is used for distinguishing speakers having similar Formants from each other. When the combination of the nonlinear and linear features of the speech signal is used, a stable speaker recognition rate can be obtained even for similar speakers having similar sound characteristics in a linear space.

Time series data has been analyzed based on the structure of speaking organs and the structure of hearing organs of the human body, which are considered to have a spectrum function. The spectrum domain is used as a space for sounds. However, sound analysis on a nonlinear space, not on the spectrum domain, is required in order to understand nonlinearity of sounds. The sound analysis on the nonlinear space provides very useful characteristics for distinguishing speakers having similar characteristics in the spectrum domain from one another. However, utilization of only the nonlinear feature deteriorates the performance of system. Thus, it is required to properly combine the linear feature (for example, MFCC, LPC, LSF and so on) with the nonlinear feature (for example, correlation dimension, Lyapunov index, Lyapunov dimension, Kolmogorov dimension, fractal dimension and so on). That is, a stable speaker recognition system can be constructed using both of the linear and nonlinear features even when trained sound databases have similarity in a linear space because sounds of speakers have both of the linear and nonlinear features.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a Formant graph with respect to “female pair 2”;

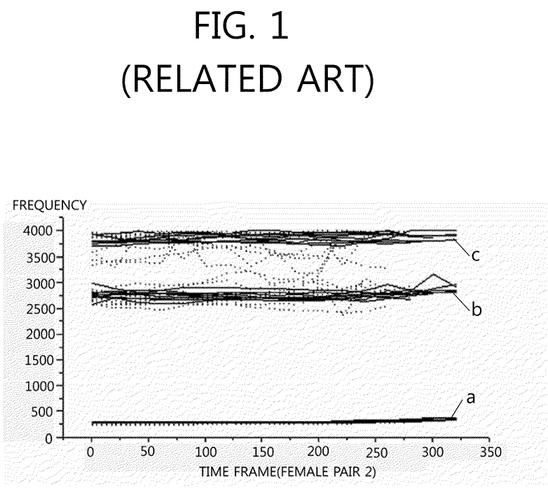

FIG. 2 is a Formant graph with respect to “female pair 1”;

FIG. 3 is a Formant graph with respect to “male pair 1”;

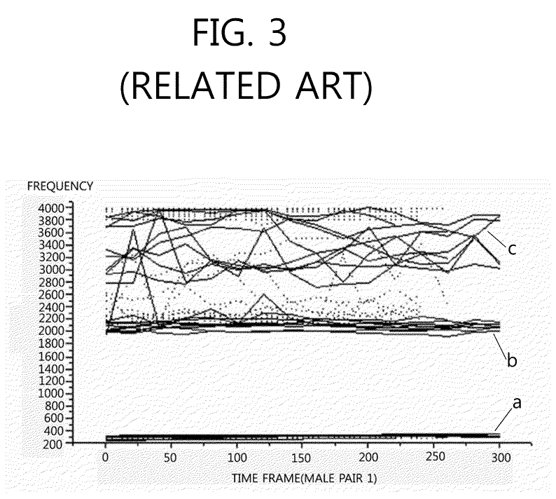

FIG. 4 illustrates a speaker recognition system according to the present invention;

FIG. 5 illustrates a Mel scaling filter bank on the spectrum domain;

FIG. 6 illustrates MFCC of a sound;

FIG. 7 is a graph showing a final recognition rate with respect to speakers having similar sounds;

FIG. 8 illustrates a speaker recognition system using linear and nonlinear features according to a first embodiment of the present invention;

FIG. 9 illustrates a speaker recognition system using linear and nonlinear features according to a second embodiment of the present invention;

FIG. 10 illustrates a speaker recognition system using linear and nonlinear features according to a third embodiment of the present invention; and

FIG. 11 illustrates a speaker recognition system using linear and nonlinear features according to a fourth embodiment of the present invention.

### DETAILED DESCRIPTION OF THE PREFERRED EMBODIMENT

Reference will now be made in detail to the preferred embodiments of the present invention, examples of which are illustrated in the accompanying drawings.

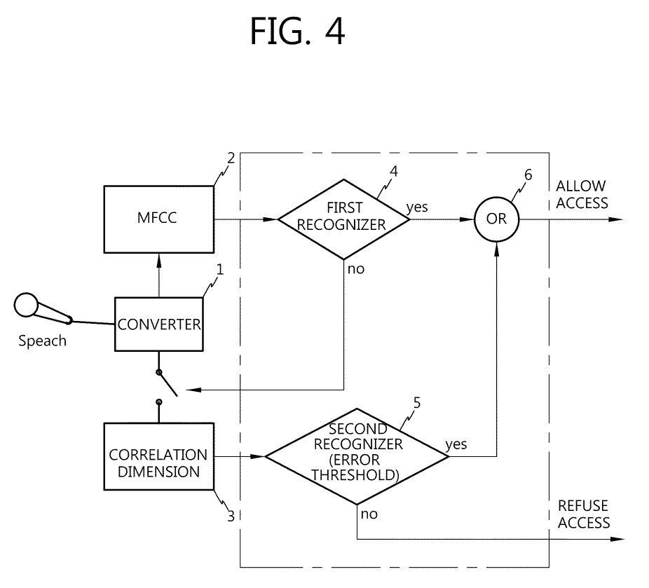

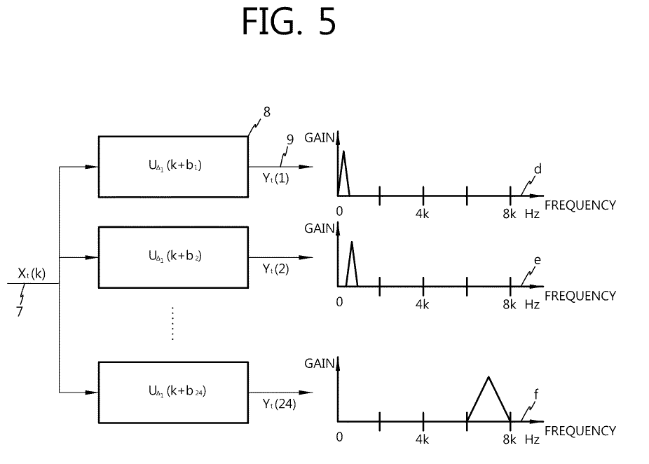

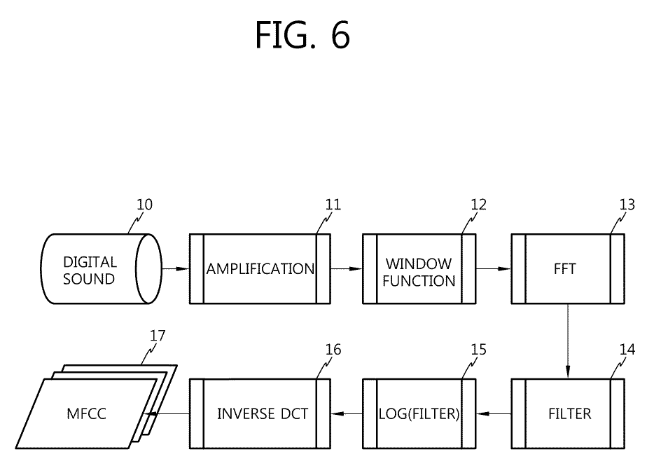

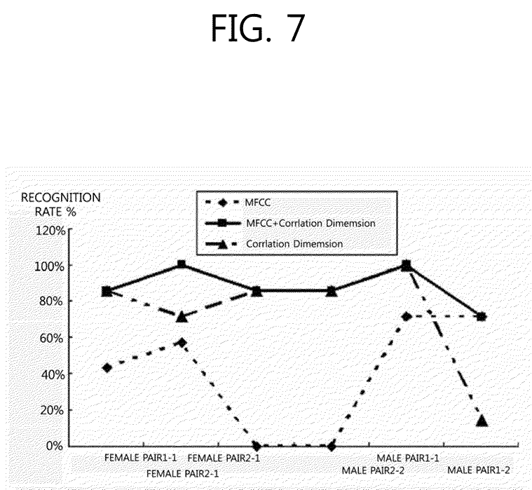

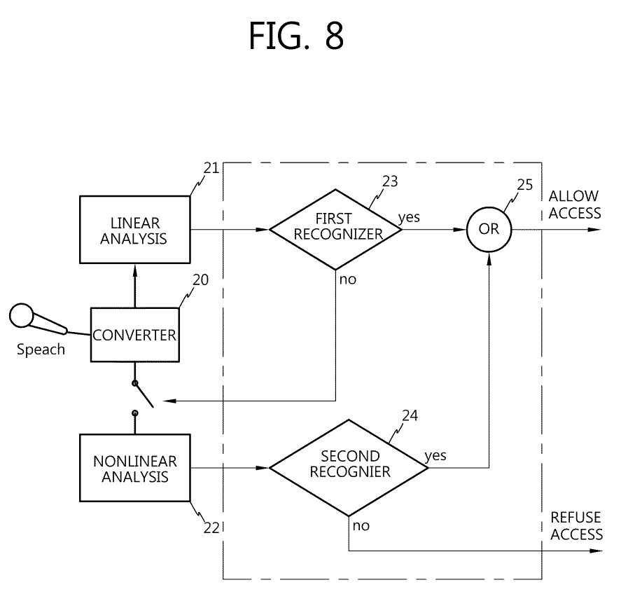

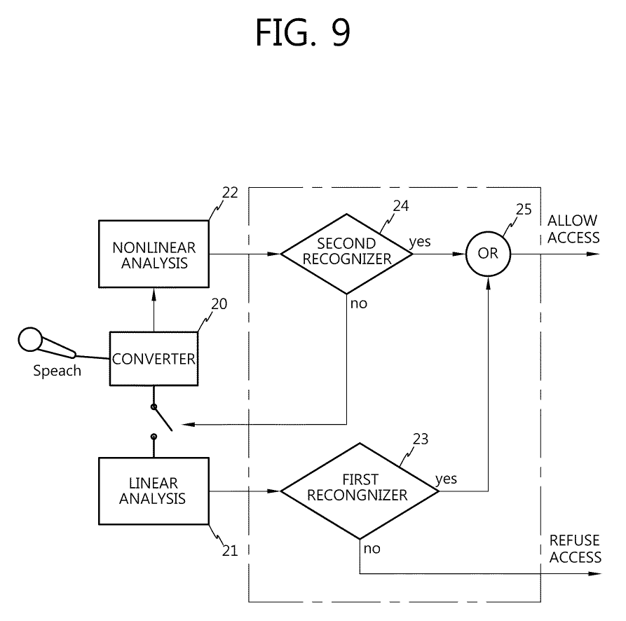

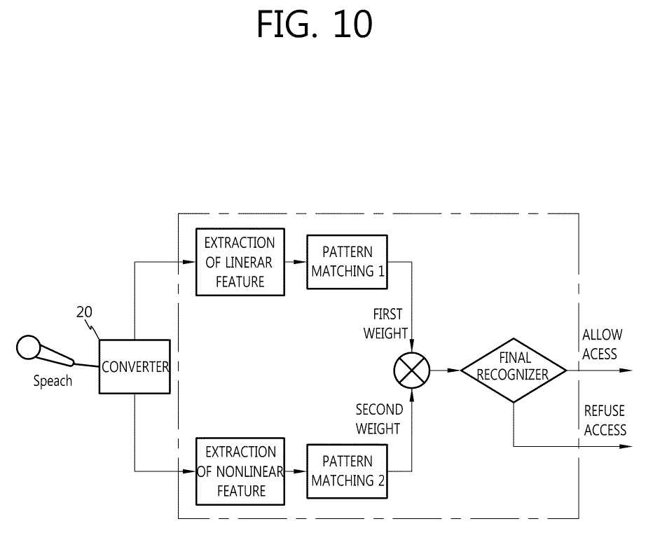

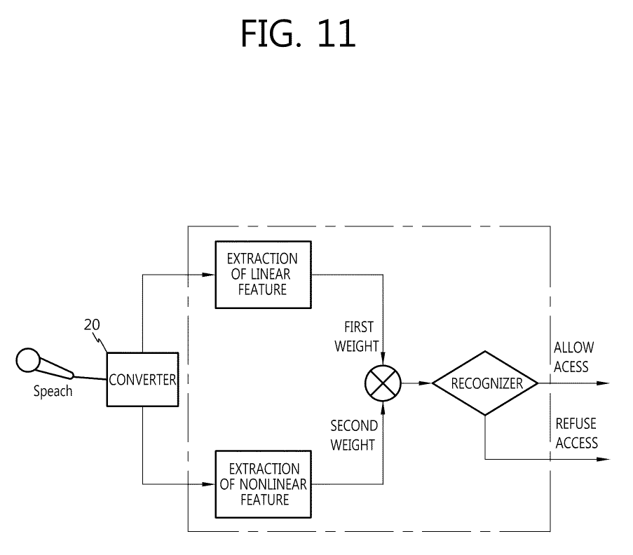

FIG. 4 illustrates a speaker recognition system according to the present invention, FIG. 5 illustrates a Mel scaling filter bank in the spectrum domain, and FIG. 6 illustrates MFCC of a sound. FIG. 7 is a graph showing a final recognition rate with respect to speakers having similar sounds, FIG. 8 illustrates a speaker recognition system using linear and nonlinear features according to a first embodiment of the present invention, and FIG. 9 illustrates a speaker recognition system using linear and nonlinear features according to a second embodiment of the present invention. FIG. 10 illustrates a speaker recognition system using linear and nonlinear features according to a third embodiment of the present invention, and FIG. 11 illustrates a speaker recognition system using linear and nonlinear features according to a fourth embodiment of the present invention.

The speaker recognition system of FIG. 4 is an application of the speaker recognition system using linear and nonlinear features according to the first embodiment of the present invention, shown in FIG. 8. The speaker recognition system of FIG. 4 uses MFCC (Mel frequency cepstrum coefficient) 2 as a linear feature and uses a correlation dimension 3 as a nonlinear feature. Furthermore, the system uses CHMM (continuous hidden Markov model) as a first recognizer 4 for recognizing the linear feature. The system further includes a second recognizer 5 for recognizing the nonlinear feature. The second recognizer 5 uses two thresholds. The first one of the two thresholds is an error threshold for measuring similarity between test data and training data and the second one corresponds to a difference between first and second maximum log probabilities. The first threshold corresponds to 30% of the maximum log probability and the second threshold uses 30% of a difference between the first and second maximum log probabilities in the training data.

The speaker recognition system of FIG. 4 includes an A/D converter 1, MFCC 2, correlation dimension 3, first and second recognizers 4 and 5, and a logic element 6.

A similar speaker recognition method using nonlinear analysis according to the present invention includes a step in which the A/D converter converts an analog sound signal of a speaker into a digital sound signal, a step in which the first recognizer 4 matches the MFCC 2 of the digital sound signal with linear features of a previously trained sound, a step of allowing access of the speaker when the MFCC of the digital sound signal is matched with the linear features of a previously trained sound and extracting the correlation dimension 3 from the digital sound signal when the MFCC of the digital sound signal is not matched with the linear features of a previously trained sound, a step in which the second recognizer 5 matches the correlation dimension 3 with nonlinear features of the previously trained sound, and a step of allowing access of the speaker when the correlation dimension is matched with the nonlinear features of the previously trained sound and refusing access of the speaker when the correlation dimension is not matched with the nonlinear features of the previously trained sound.

[Extraction of Linear Feature of Sound: MFCC]

A method of extracting the MFCC 2 shown in FIG. 4 will now be explained.

In speech recognition, conventional characteristics estimating characteristic parameters include filter bank analysis and linear prediction. The present invention predicts linear characteristic parameters through Mel scale filter bank analysis using the human hearing structure. FIG. 5 illustrates the Mel scaling filter bank in the spectrum domain and shows a process of inputting a sound signal 7 in the spectrum domain and outputting the sound signal through a filter bank 8. Graphs of FIG. 5 show shapes and bandwidths at frequencies corresponding to the outputs of filters of the filter bank. Each filter uses a triangular filter in consideration of the human hearing structure. For reference, Mel scaling used is linear frequencies of up to 1 kHz and algebraically nonlinear for frequencies higher than 1 kHz. Thus, the filter bank is sensitive to a small change in a low frequency domain but less sensitive in a high frequency domain. The filter bank is called perceptual weighting characteristic because it is based on the human hearing structure.

FIG. 5 shows that a sound of a person is analyzed with the human hearing structure (Mel). The following equation represents Mel scaling that transforms a frequency f(Hz) in the spectrum domain into a Mel frequency domain Mel(f).

$$Mel ( f ) = 2595 {log}_{10} ( 1 + \frac{f}{700} ) \qquad ( 1 )$$

FIG. 6 shows a process of inputting a sound signal 10 and extracting MFCC 17. A high frequency region of the sound signal 10 is amplified (11), the sound signal 10 is divided through a window function 12, and divided sound data is fast-Fourier-transformed (13). Then, the log of the output of a Mel scaling filter 14 is obtained (15) and the result is inverse-discrete-cosine-transformed (16) to extract the MFCC 17.

[Transform into Phase Domain]

A method of transforming a sound signal in the time domain into a sound signal in the phase domain as a pre-process for extracting the correlation dimension 3 of FIG. 4 will now be explained.

To understand nonlinearity of a sound, it is required to analyze the sound in the phase domain, not in the spectrum domain. Since fundamental nonlinearity caused by a sound uttering system can be analyzed in the phase domain, a sound in the time domain should be transformed into status vectors in the phase domain for nonlinearity analysis. For example, a technique of transforming a sound in the time domain into a sound in the phase domain through a delay reconstruction method for maintaining nonlinear characteristic of the sound. The following equation represents m-dimensional delay reconstruction for a current-status-dependent sound. Equation 2 shows a method of transforming a sound in the time domain into a sound in the phase domain.

βₙ=(sₙ₋₍ₘ₋₁₎ᵥ·sₙ₋₍ₘ₋₂₎ᵥ, . . . , sₙ₋ᵥ,sₙ) (2)

When sₙ is the nth sound sample and v is a delay order, the sound can be transformed into an m-dimensional status vector βₙ. Here, βₙ represents a status vector on the phase domain with respect to the sound sₙ on the time domain.

[Extraction of Nonlinear Feature: Correlation Dimension]

A method of extracting the correlation dimension 3 of FIG. 4 will now be explained.

A sound signal in the time domain is transformed into a sound signal in the phase domain, and then a nonlinear feature of the sound signal is extracted on the phase domain. To extract the nonlinear feature of the sound signal on the phase domain, various nonlinear analysis methods can be used. For instance, a correlation dimension on the phase domain can be used. A fractal dimension D_{q}(Q,p) is defined as follows in order to calculate the correlation dimension.

$${D}_{q} ( Q , ρ ) = \frac{1}{q - 1} {lim}_{ɛ -> 0} \frac{log {\sum }_{i = 1}^{N ( ɛ , Q )} {ρ}^{q} [ {Q}_{i} ( ɛ ) ]}{log ɛ} \qquad ( 3 )$$

If q is 2 in the fractal dimension D_{q}, this is called a correlation dimension D₂.

$${D}_{2} ( Q ) = {lim}_{ɛ -> 0} \frac{log {\sum }_{i = 1}^{N ( ɛ , Q )} {ρ}^{2} [ {Q}_{i} ( ɛ ) ]}{log ɛ} \qquad ( 4 )$$

In practice, D₂(Q) is obtained using the gradient of log C₂(dᵣ; ε) and log ε. However, it is not easy to define the value of D₂(Q) because the gradient is not linear in all regions. The gradient is linear only in a limited region of ε. When a linear region of ε exists, an effective range of this region is called scaling region. The size of the linear scaling region decides reliable D₂(Q) in the sound of each speaker.

### Environment for Embodiments

The following environment was applied to the embodiment shown in FIG. 4. Sound data items were collected from two pairs of females and a pair of males (total six speakers) and recorded, the females and males of each pair having very similar sounds. When the sound data items were obtained, a hearing test was used as a similarity standard for judging whether the females and males can be distinguished from each other. Since the Korean vowel /i/ is more chaotic than /a/, /e/, /o/ and /u/, the vowels /i/ pronounced by each speaker ten times were collected through an A/D converter at 44 kHz sampling and 16-bit resolution. The collected sound data passed through a pre-emphasis filter for amplifying RF bands and a hamming window of 25 ms. 12-order fundamental MFCC, first-order energy, and 39-order MFCC characteristic vector (2 in FIG. 4) using first-order differential value Δ and second-order differential value ΔΔ with respect to the fundamental MFCC and first-order energy were used. For a recognition algorithm, CHMM having 5-status Gaussian density (4 in FIG. 4) were used for each speaker. Furthermore, first, second and third Formants of one speaker of each pair were compared to the first, second and third Formants of the other speaker in order to compensate ambiguity that may generate in the hearing test for each vowel /i/ for similarity standard. In most cases, Formant depends on an uttering structure and vocal track based on age and sex, and a fundamental frequency and a frequency bandwidth, which affect sound characteristics such as tone and pitch, are varied in the Formant. Accordingly, the Formant affects the calculation of MFCC estimated by a band filter and it can be predicted that it is impossible to distinguish speakers having similar Formant structures from each other with CHMM using MFCC characteristics.

The present invention used sound data whose noise was reduced through local projective noise reduction. A silence period was removed from sounds pronounced by each of the six speakers three times, a recognizer performed training thousand times using the sounds, and other sounds were used for estimating a recognition rate.

### Embodiment Results

FIG. 7 is a graph showing recognition rates with respect to speakers having similar sounds. In FIG. 7, a graph (h) shows recognition rates when only the linear features of sounds are used, a graph (g) shows recognition rates when only the nonlinear features of the sounds are used, and a graph (i) shows recognition rates when a combination of the linear and nonlinear features is used. In FIG. 7, X-axis represents the speakers and Y-axis represents speaker recognition rates of the respective speakers.

It can be seen from FIG. 7 that an average recognition rate (graph (g) of FIG. 7) is less than 40% when the speakers are recognized using only the linear features of their sounds and all the recognition rates (graph (i) of FIG. 7) are increased higher than 60% when the speakers are recognized using the combination of the linear and nonlinear features of their sounds.

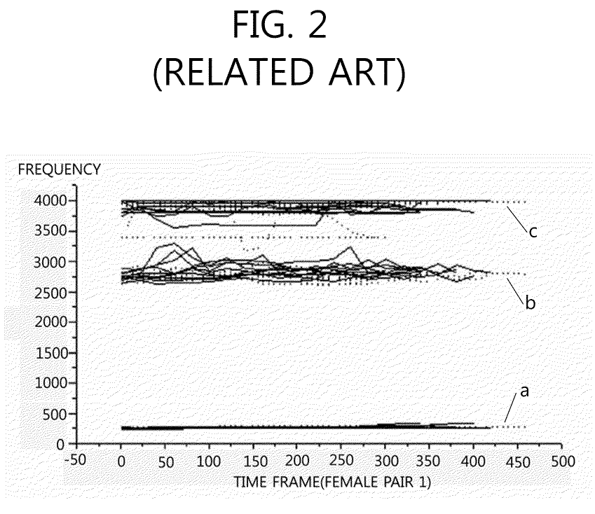

Furthermore, it can be seen that the recognition rates are approximately 0% when only the linear features are used for the female 2-1 and female 2-2 (graph (g) of FIG. 7). This is because the two speakers have very similar Formants as shown in FIG. 2. A very low recognition rate is obtained when speakers have very similar Formants. Even Probability with respect to speaker similarity was much larger than an error threshold of test data. That is, the test data used for a recognition experiment did not satisfy the threshold while training data correctly satisfied the threshold. This result shows that only the linear features of the sounds are difficult to tell a difference between the sounds of the speakers of “female pair 2”. However, the recognition rate was increased to 47% when the correlation dimension, a nonlinear feature, was added to MFCC, a linear characteristic, under the same experimental condition. In other words, the test data that was analyzed through linear features was reconfirmed using the correlation dimension. In fact, a very small difference between log probabilities in the test data items of the speakers of “female pair 2” makes speaker recognition difficult. However, the difference becomes distinct when the nonlinear feature (correlation dimension) is added to the linear feature.

It should be noted that speakers who are easily distinguished from each other using the linear feature are difficult to discriminate from each other when only the nonlinear feature (correlation dimension) is used without using the linear feature. This results in a poor speaker recognition result (graph (h) of FIG. 7). Accordingly, it can be known that the nonlinear feature of a sound signal must be combined with its linear feature.

FIG. 8 illustrates a speaker recognition system using linear analysis and nonlinear analysis according to the first embodiment of the present invention. Similarly to the system of FIG. 4, the speaker recognition system of FIG. 8 recognizes a speaker using a linear feature first and then recognize the speaker using a nonlinear feature based on the first recognition result. The speaker recognition process of the system includes a step 21 of extracting a linear characteristic of a sound signal, a step 23 in which a first recognizer matches the linear feature with previously trained sounds, a step 22 of allowing access of the speaker when the linear feature is matched with the trained sounds and switching to nonlinear feature extraction when it is not, a step 24 in which a second recognizer matches the nonlinear feature with the trained sounds, and a step of allowing access of the speaker when the nonlinear feature is matched with the trained sounds but refusing access of the speaker when it is not.

FIG. 9 illustrates a speaker recognition system using linear analysis and nonlinear analysis according to the second embodiment of the present invention. The speaker recognition process of the system includes a step 21 of extracting a nonlinear feature of a sound signal, a step 23 in which a first recognizer matches the nonlinear feature with previously trained sounds, a step 22 of allowing access of the speaker when the nonlinear feature is matched with the trained sounds and switching to linear feature extraction when it is not, a step 24 in which a second recognizer matches a linear feature with the trained sounds, and a step of allowing access of the speaker when the linear feature is matched with the trained sounds and refusing the access of the speaker when it is not.

FIG. 10 illustrates a speaker recognition system using linear analysis and nonlinear analysis according to the third embodiment of the present invention. The speaker recognition system simultaneously extracts linear and nonlinear features from an input sound of a speaker and matches each of the linear and nonlinear features with previously trained sounds. Then, the system gives first and second weights to distances between the linear and nonlinear features and the trained sounds, respectively, and inputs them to a final recognizer to determine whether access of the speaker is allowed or refused. The system of FIG. 10 uses the weights in order to emphasize one of the linear and nonlinear features, if required, when the linear and nonlinear features are simultaneously used.

FIG. 11 illustrates a speaker recognition system using linear analysis and nonlinear analysis according to the fourth embodiment of the present invention. The system of FIG. 11 simultaneously extracts linear and nonlinear features as does the system of FIG. 10. The system of FIG. 11 respectively gives appropriate weights to the linear and nonlinear features, if required, to generate a single characteristic vector for an input sound and carries out speaker recognition using the characteristic vector.

The present invention uses a combination of linear and nonlinear features of a sound to remarkably improve a recognition rate, compared to the conventional technique of using only linear feature of a sound signal.

It can be seen that sounds of speakers have both of linear and nonlinear features through the aforementioned embodiments. That is, speakers having different Formants are distinguished through linear analysis and speakers having similar Formants are distinguished through nonlinear analysis. Accordingly, the technique of using both of the linear and nonlinear features of a sound signal can overcome the limitation of a linear algorithm.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

As described above, the present invention considerably improves a recognition rate using a combination of MFCC (linear characteristic) and correlation dimension (nonlinear characteristic). This means that both of the linear and nonlinear features of a sound are important.

The present invention distinguishes speakers having different Formants from each other through linear analysis and distinguishes speakers having similar Formants from each other through nonlinear analysis. Accordingly, the present invention can overcome the limitation of the conventional linear algorithm by using both of linear and nonlinear features of a sound signal for the analysis of the sound signal. Furthermore, the present invention can be applied to sound-related application systems other than speaker recognition systems from the fact that both of the linear and nonlinear features of a sound signal are important.

According to U.S. TMA report, it is expected that the speaker recognition market shows yearly average growth rate of 65.4% from 2000 to 2004 and has the scale of 1616000000 dollars in 2004. This is considerably rapid growth speed, taking into account the yearly average growth rate of software of 14.5% during the same period. The problem of similar speaker recognition proposed by the present invention must be solved rapidly because most of speaker recognition systems are applied to security systems. Accordingly, considerable economical pervasive effect is expected when the present invention is applied to the speaker recognition systems. Furthermore, commercialization prospects are very bright when the core technology of speaker recognition is possessed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A similar speaker recognition method, comprising the steps of:
receiving a sound signal;
extracting a first feature from the sound signal;
extracting a second feature from the sound signal;
comparing the first feature with a prestored sound data, thereby generating a first comparing value;
comparing the second feature with the prestored sound data if the first comparing value is within a certain range, thereby generating a second comparing value; and
estimating that the sound signal and the prestored sound data are of same speaker if the second comparing value is within a threshold range,
wherein the first feature is a linear feature and the second feature is a nonlinear feature.

2. The method as claimed in claim 1, wherein the first feature is extracted in a frequency domain and the second feature is extracted in a phase domain.

3. The method as claimed in claim 1, wherein the first feature uses MFCC(MelFrequency Cepstrum) and the second feature uses correlation dimension.

4. The method as claimed in claim 1, wherein a weight is applied to each of the first feature and the second feature to compare the first feature and the second feature with the prestored sound data.

5. The method as claimed in claim 1, wherein the threshold range is a error threshold range for measuring a similarity between the second feature and the prestored sound data.

6. An apparatus for similar speaker recognition, comprising:
receiver for receiving a sound signal;
a first recognizer configured to generate a first comparing value by comparing a linear feature of the sound signal with a prestored sound data;
a second recognizer configured to generate a second comparing value by comparing a nonlinear feature of the sound signal with the prestored sound data when the first comparing value is within a certain range; and
a logic means configured to reject or allow an access by the second comparing value.

7. The apparatus as claimed in claim 6, wherein a weight is applied to each of the first feature and the second feature to compare the first feature and the second feature with the prestored sound data.
